(19) United States
(12) Patent Application Publication
(10) Pub. No.: US 2026/0323768 A1
(43) Pub. Date: Oct. 15, 2026

(54) METHOD AND APPARATUS FOR HANDLING UNALLOWED SERVICE

(71) Applicant: Samsung Electronics Co., Ltd., Suwon-si, Gyeonggi-do (KR)

(72) Inventors: Lalith KUMAR, Bangalore (IN); Koustav ROY, Bangalore (IN); Danish Ehsan HASHMI, Bangalore (IN); Jagadeesh GANDIKOTA, Bangalore (IN); Krishnamurthy D R, Bangalore (IN); Ashok Kumar NAYAK, Bangalore (IN)

(21) Appl. No.: 19/483,825

(22) PCT Filed: May 10, 2024
(86) PCT No.: PCT/KR2024/006330

§ 371 Date: Nov. 12, 2025

(30) Foreign Application Priority Data
May 12, 2023 (IN) 202341033694
Apr. 25, 2024 (IN) 2023 41033694

(51) Int. Cl. H04W 76/30; H04W 48/20

(52) U.S. Cl. CPC H04W 76/30; H04W 48/20

(57) ABSTRACT

The disclosure relates to a 5G or 6G communication system for supporting a higher data transmission rate. A method performed by an access management function (AMF) entity in a wireless communication system, the method comprising: receiving, from a session management function (SMF) entity, single network slice selection assistance information (S-NSSAI) for requesting the AMF entity to report whether a user equipment (UE) is inside a first area; and transmitting, to the SMF entity, a result for an identification on whether the UE is inside the first area, based on the S-NSSAI.

### TECHNICAL FIELD

The embodiments disclosed herein generally relate to the field of network, and more particularly to a system and method to handle a user plane resource in a non-supported area.

### BACKGROUND ART

In a 3^{rd} Generation Partnership Project (3GPP) specification, a Single-Network Slice Selection Assistance Information (S-NSSAI-1) is configured in a partially allowed NSSAI list and/or a S-NSSAIs rejected partially in a Registration Area (RA) indicating supported list of Tracking Area Identity (TAIs) as TAI-1 and a current Registration Area includes TAI-1 and TAI-2 for a User Equipment (UE). The UE is already established Protocol Data Unit (PDU) session identifier (ID)-1 with corresponding S-NSSAI as S-NSSAI-1 while the UE is on TAI-1. The UE moves to TA-2 and sends an UpLink Non Access Stratum (UL NAS) message e.g. Service request message with Uplink data status IE for PDU Session id-1 to indicate the PDU session(s) for which the UE has pending user data to be sent. The network is not able to establish user plane resources for PDU-session 1, thus the network may send service accept without establishing the UP resources. But the application on the UE wants to send data over the same PDU session thus the UE will again send service requests message and this will continue in the loop unnecessarily utilizing the network resources and UE power. Another problem is if the UE has any downlink or mobile terminated data how will the system handle it if the UE is in the non allowed/supported area for the PDU session of respective S-NSSAI.

The above information is presented as background information only to help the reader to understand the present invention. Applicants have made no determination and make no assertion as to whether any of the above might be applicable as prior art with regard to the present application.

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

### DISCLOSURE OF INVENTION

### Solution to Problem

A method performed by an access management function (AMF) entity in a wireless communication system, the method comprising: receiving, from a session management function (SMF) entity, single network slice selection assistance information (S-NSSAI) for requesting the AMF entity to report whether a user equipment (UE) is inside a first area; and transmitting, to the SMF entity, a result for an identification on whether the UE is inside the first area, based on the S-NSSAI, wherein, in case that the UE is not inside the first area, downlink user data is not transmitted.

A method performed by a session management function (SMF) entity in a wireless communication system, the method comprising: transmitting, to an access management function (AMF) entity, single network slice selection assistance information (S-NSSAI) for requesting the AMF entity to report whether a user equipment (UE) is inside a first area; and receiving, from the AMF entity, a result for an identification on whether the UE is inside the first area, based on the S-NSSAI, wherein, in case that the UE is not inside the first area, downlink user data is not transmitted.

An access management function (AMF) entity in a wireless communication system, the AMF entity comprising: a transceiver; and a controller coupled with the transceiver and configured to: receive, from a session management function (SMF) entity, single network slice selection assistance information (S-NSSAI) for requesting the AMF entity to report whether a user equipment (UE) is inside a first area, transmit, to the SMF, a result for an identification on whether the UE is inside the first area, based on the S-NSSAI, wherein, in case that the UE is not inside the first area, downlink user data is not transmitted.

A session management function (SMF) entity in a wireless communication system, the SMF comprising: a transceiver; and a controller coupled with the transceiver and configured to: transmit, to an access management function (AMF) entity, single network slice selection assistance information (S-NSSAI) for requesting the AMF entity to report whether a user equipment (UE) is inside a first area, and receive, from the AMF entity, a result for an identification on whether the UE is inside the first area, based on the S-NSSAI, wherein, in case that the UE is not inside the first area, downlink user data is not transmitted.

### BRIEF DESCRIPTION OF DRAWINGS

The invention is illustrated in the accompanying drawings, throughout which like reference letters indicate corresponding parts in the various figures. The embodiments herein will be better understood from the following description with reference to the drawings, in which:

FIG. 1 is a sequence diagram of a UE sending a service request in a non-supported area in a wireless network, according to a prior art.

FIG. 2 is a sequence diagram of a network sending a reject with cause to a UE in the wireless network, according to the embodiments disclosed herein.

FIG. 3 is a sequence diagram illustrating various scenarios of a downlink data handling in the non-supported area in a connected mode (CM), according to the embodiments disclosed herein.

FIG. 4 shows various hardware components of a UE, according to the embodiments as disclosed herein.

FIG. 5 shows various hardware components of an AMF entity, according to the embodiments as disclosed herein.

FIG. 6 is a flow chart illustrating a method, implemented by the UE, for handling a user plane resource in a non-supported area, according to the embodiments as disclosed herein.

FIG. 7 and FIG. 8 are flow charts illustrating a method, implemented by the AMF entity, for handling the user plane resource in a non-supported area, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The principal object of the embodiments herein is to provide a method for handling a user plane resource in a non-supported area.

Another object of the embodiments herein is to request, by a UE, to establish the user plane resource in an uplink data status information element (IE) for a PDU session.

Another object of the embodiments herein is to receive, by the UE, a Non-access stratum (NAS) message from an Access and Mobility Management Function (AMF) entity. The NAS message indicates a cause to the UE that a uplink (UP) resources establishment has failed due to the non-supported area of a S-NSSAI.

Another object of the embodiments herein is to stop, by the UE, to attempt to the request for the user plane resource in the non-supported area for the PDU session of the S-NSSAI.

Another object of the embodiments herein is to determine, by an AMF entity, whether the UE is in an allowed area for the S-NSSAI or not in the allowed area for a S-NSSAI from a network node.

Another object of the embodiments herein is to indicate to a SMF entity that the UE is not in an allowed area for a S-NSSAI when the UE moves out of the allowed area for the S-NSSAI. The SMF entity blocks a data by disabling a data notification or release of the PDU session of that S-NSSAI or by not sending user data as payload of NAS message to the UE.

Another object of the embodiments herein is to indicate to the SMF entity that the UE is in the allowed area for the S-NSSAI when the UE moves inside the allowed area for the S-NSSAI, where the SMF entity starts sending the data or receiving the data.

Embodiments disclosed herein provide a method for handling a user plane resource in a non-supported area. The method includes requesting, by a UE, to establish the user plane resource in an uplink data status IE for a PDU session. Further, the method includes receiving, by the UE, a Non-access stratum (NAS) message from an Access and Mobility Management Function (AMF) entity. The NAS message indicates a cause to the UE that a uplink (UP) resources establishment has failed due to the non-supported area of a S-NSSAI. Further, the method includes stopping, by the UE, to attempt to the request for the user plane resource in the non-supported area for the PDU session of the S-NSSAI.

In an embodiment, stopping to attempt to request for the user plane resources is for certain duration of time, wherein the certain duration is calculated by the UE based on implementation or indicated by a network along with the cause in the NAS message.

In an embodiment, the NAS message is one of a service accept message or a registration accept message, where the service accept message or the registration accept message includes the PDU session reactivation result IE. The PDU session reactivation result IE indicates a cause to the UE that the UP resources establishment has failed due to the non-supported area.

In an embodiment, the AMF entity determines that the UE is in the non-supported area for the PDU session for the S-NSSAI when the UE is not inside a network slice area of service (NS-AoS) of the S-NSSAI of the PDU session or the UE is a Tracking Area Identity (TAI) which does not support the S-NSSAI of the PDU session based on a Partially allowed NSSAI list or S-NSSAIs rejected partially in a Routing Area (RA).

In this embodiment, the term S-NSSAIs rejected partially in a Routing Area (RA) and Partially rejected NSSAI are used interchangeably and have same meaning.

Embodiments disclosed herein provide a method for handling a user plane resource in a non-supported area. The method includes sending, by an AMF entity, a NAS message to a UE. The NAS message indicates a cause to the UE that a UP resources establishment has failed due to a non-supported area of a S-NSSAI, when the UE requests to establish the user plane resource in an uplink data status IE for a PDU session. Further, the method includes handling, by the AMF entity, the user plane resource in the non-supported area based on the NAS message.

Embodiments disclosed herein provide a method for handling a user plane resource in a non-supported area. The method includes determining, by an AMF entity, whether a UE is in an allowed area for the S-NSSAI or not in the allowed area for a S-NSSAI from a network node. In an embodiment, the method includes indicating to a SMF entity that the UE is not in an allowed area for the S-NSSAI when the UE moves out of the allowed area for the S-NSSAI. The SMF entity blocks a data by disabling a data notification or release/deactivates the PDU session of that S-NSSAI or by not sending user data as payload of NAS message to the UE. Further, the method includes indicating to the SMF entity that the UE is in the allowed area for the S-NSSAI when the UE moves inside the allowed area for the S-NSSAI, wherein the SMF entity starts sending the data or receiving the data.

In an embodiment, the AMF entity determines that the UE is in the allowed area or not allowed area using a user location information received in a N2 message from the network node.

In an embodiment, the AMF entity determines that UE is in the allowed area or not allowed area by creating an area of interest (AOI) and indicating to the network node (i.e. the NG-RAN node), and receiving the information on the UE location from the network node based on the indicated Area of interest and notifies the result to the SMF.

In an embodiment, the AMF entity determines that the UE is in the allowed area or not in the allowed area based on the NS-AoS, a Partially allowed NSSAI list or S-NSSAIs rejected partially in the RA(also called as Partially rejected NSSAI).

In an embodiment, the SMF entity registers with the AMF entity by indicating the S-NSSAI to determine if the UE is in the allowed area or not in the allowed area of a respective S-NSSAI. That is, in the case of Partial Network Slice Support and Support for Network Slices with the Network Slice Area of Service not matching deployed Tracking Areas, the SMF entity provides the S-NSSAI to the AMF entity in the “UE mobility event notification” for reporting UE presence in a slice restriction area.

In an embodiment, the network node is a NG-RAN node.

Embodiments disclosed herein provide a UE for handling a user plane resource in a non-supported area. The UE includes a user plane resource controller communicatively coupled to a memory and a processor. The user plane resource controller is configured to request to establish the user plane resource in an uplink data status IE for a PDU session. Further, the user plane resource controller is configured to receive the NAS message from the AMF entity. The NAS message indicates a cause to the UE that the UP resources establishment has failed due to the non-supported area of a S-NSSAI. Further, the user plane resource controller is configured to stop to attempt to the request for the user plane resource in the non-supported area for the PDU session of the S-NSSAI.

Embodiments disclosed herein provide an AMF entity for handling a user plane resource in a non-supported area. The AMF entity includes a user plane resource controller communicatively coupled to a memory and a processor. The user plane resource controller is configured to send a NAS message to a UE. The NAS message indicates a cause to the UE that the UP resources establishment has failed due to a non-supported area of a S-NSSAI, when the UE requests to establish the user plane resource in an uplink data status IE for a PDU session. Further, the user plane resource controller is configured to handle the user plane resource in the non-supported area based on the NAS message.

Embodiments disclosed herein provide an AMF entity for handling a user plane resource in a non-supported area. The AMF entity includes a user plane resource controller communicatively coupled to a memory and a processor. The user plane resource controller is configured to determine whether the UE is in an allowed area for the S-NSSAI or not in the allowed area for a S-NSSAI from a network node. In an embodiment, the user plane resource controller is configured to indicate to a SMF entity that the UE is not in an allowed area for the S-NSSAI when the UE moves out of the allowed area for the S-NSSAI. The SMF entity blocks the data by disabling the data notification or release of the PDU session of that S-NSSAI or by not sending user data as payload of NAS message to the UE. Further, the user plane resource controller is configured to indicate to the SMF entity that the UE is in the allowed area for the S-NSSAI when the UE moves inside the allowed area for the S-NSSAI. The SMF entity starts sending the data or receiving the data.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Embodiments disclosed herein provide a method for handling a user plane resource in a non-supported area. The method includes requesting, by a UE, to establish the user plane resource in an uplink data status IE for a PDU session. Further, the method includes receiving, by the UE, a NAS message from an AMF entity. The NAS message indicates a cause to the UE that a UP resources establishment has failed due to the non-supported area of a S-NSSAI. Further, the method includes stopping, by the UE, to attempt to the request for the user plane resource in the non-supported area for the PDU session of the S-NSSAI.

Embodiments disclosed herein provide a system and method to handle downlink data in a non-supported area. Current embodiment disclosed various network function entity and UE behaviour in case downlink data arrives for a PDU session which is associated with a network slice (i.e., S-NSSAI) and the UE is in non-allowed area for the corresponding network slice

Embodiments disclosed herein provide a method and system to handle downlink data in a non-supported area. A Network Slice is supported in one or more Tracking Area (TAs) in a Public Land Mobile Network (PLMN) or Standalone Non-Public Network (SNPN). A partial network slice support in the RA for a UE includes configuring the UE with a partially allowed NSSAI and/or S-NSSAI rejected partially in the RA. The partially allowed NSSAI indicates S-NSSAIs values for a UE in the serving PLMN or SNPN with some of TAs in a current Registration Area. Each S-NSSAI in the partially allowed NSSAI is associated with a list of TAs where the S-NSSAI is supported. If received, the S-NSSAI rejected partially in the RA is stored in the UE while RM-REGISTERED until the UE moves out of the current registration area or until the S-NSSAI is deleted.

Below are the abbreviations used in the patent specification:
1. UP: User Plane
2. UE: User Equipment
3. AMF: Access and Mobility Management Function
4. SMF: Session Management Function
5. UPF: User Plane Function
6. PCF: Policy Control Function
7. PDU: Packet Data Unit
8. SR: Service Request
9. TAI: Tracking Area Identity
10. TAC: Tracking Area Code
11. 3GPPA: 3GPP Access
12. N3GPPA: Non 3GPP Access
13. 3GPP: 3rd generation partnership project
14. MA PDU: Multi Access-PDU
15. RAT: Radio Access Technology
16. DL: Downlink
17. NAS: Non Access Stratum
18. AF: Application Function.
19. NTN: Non Terrestrial Networks
20. AOI: Area Of interest
21. NS-AOS: Network Slice Area of Service
22. 5GS: 5G System
23. EPS: Evolved Packet System
24. TA: Tracking Area
25. RA: Registration Area.

In an embodiment, a 5G system (5GS) also be referred to a N1-mode or New Radio (NR) or Next Generation Radio Access Network (NG-RAN) or 5G.

The term 5GMM sublayer states in the embodiment is at least one of the below:
1) 5GMM-NULL
2) 5GMM-DEREGISTERED
a) 5GMM-DEREGISTERED. NORMAL-SERVICE
b) 5GMM-DEREGISTERED. LIMITED-SERVICE
c) 5GMM-DEREGISTERED. ATTEMPTING-REGISTRATION
d) 5GMM-DEREGISTERED. PLMN-SEARCH
e) 5GMM-DEREGISTERED. NO-SUPI
f) 5GMM-DEREGISTERED. NO-CELL-AVAILABLE
g) 5GMM-DEREGISTERED. eCALL-INACTIVE
h) 5GMM-DEREGISTERED. INITIAL-REGISTRATION-NEEDED
3) 5GMM-REGISTERED-INITIATED
4) 5GMM-REGISTERED
a) 5GMM-REGISTERED. NORMAL-SERVICE
b) 5GMM-REGISTERED. NON-ALLOWED-SERVICE
c) 5GMM-REGISTERED. ATTEMPTING-REGISTRATION-UPDATE
d) 5GMM-REGISTERED. LIMITED-SERVICE
e) 5GMM-REGISTERED. PLMN-SEARCH
f) 5GMM-REGISTERED. NO-CELL-AVAILABLE
g) 5GMM-REGISTERED. UPDATE-NEEDED
5) 5GMM-DEREGISTERED-INITIATED
6) 5GMM-SERVICE-REQUEST-INITIATED.

5GMM-IDLE mode: In proposed method, if the term is used standalone, the UE in 5GMM-IDLE mode means the UE can be either in 5GMM-IDLE mode over 3GPP access or in 5GMM-IDLE mode over non-3GPP access.

5GMM-CONNECTED mode: In the proposed method, if the term is used standalone, the UE in 5GMM-CONNECTED mode means the UE can be either in 5GMM-CONNECTED mode over 3GPP access or in 5GMM-CONNECTED mode over non-3GPP access.

5GMM-IDLE mode over 3GPP access: The UE is in the 5GMM-IDLE mode over 3GPP access when no N1 Non Access Stratum (NAS) signalling connection between the UE and network over 3GPP access exists. The term 5GMM-IDLE mode over 3GPP access used in the proposed invention corresponds to a term CM-IDLE state for 3GPP access used in 3GPP TS 23.501.

5GMM-CONNECTED mode over 3GPP access: The UE is in the 5GMM-CONNECTED mode over 3GPP access when the N1 NAS signalling connection between the UE and network over 3GPP access exists. The term 5GMM-CONNECTED mode over 3GPP access used in the proposed invention corresponds to the term CM-CONNECTED state for 3GPP access used in 3GPP TS 23.501.

Partially Allowed NSSAI: Indicating the S-NSSAIs values the UE uses in a serving Public Land Mobile Network (PLMN) or Standalone Non-Public Network (SNPN) in some of Tracking Areas (TAs) in the current registration area. Each S-NSSAI in the Partially Allowed NSSAI is associated with a list of TAs where the S-NSSAI is supported.

NS-AOS: The slice area where the UE can access and get service of a particular network slice as more than zero resources are allocated to the network slice in the NG-RAN cells.

S-NSSAI location availability information: The S-NSSAI location availability information sent to the UE includes, for each applicable S-NSSAI of the Configured NSSAI, Location information indicating the cells of TAs in the RA where the related S-NSSAI is available if the S-NSSAI is not available in all the cells of the TA.

In an embodiment, a network support for the network slice is defined on a per Tracking Area granularity. It may be beneficial to deploy some Network Slices such that the Network Slice have a limited geographical availability that is not matching existing Tracking Area boundaries.

An operator decides to change a topology of the Tracking Areas so they match the boundaries of the Network Slice, or the operator may configure resources for the Network Slices in the cells of TAs where the Network Slices are to be available, and in areas of the TAs where the network slice is defined to be not available the cells are configured with zero resources.

An Access and Mobility Management Function (AMF) receives from an OAM the information on availability of a network slice when the granularity is smaller than TA, i.e. if the NS-AoS includes TAs where the network slice is not available in some cells of the TA.

In order to optimize an end-to-end behaviour, the AMF can, based on NS-AoS information received from the OAM, configure supporting UEs with S-NSSAI location availability information, and the 5GCnetwork may need to monitor the S-NSSAI usage and enforce the NS-AoS e.g. if the UE does not support the S-NSSAI location availability information.

The UE receives S-NSSAI location availability information applies the information as follows.

If the S-NSSAI is rejected in the RA or rejected partially in the RA or rejected with a cause code that allows attempting to register the S-NSSAI again, the UE can request the S-NSSAI only if the S-NSSAI location availability information indicates that the S-NSSAI is available at the cell where the UE is camping.

If the S-NSSAI is in the Partially Allowed NSSAI, the UE shall not activate User Plane for any already established PDU Session with that S-NSSAI if the UE is in a cell within the RA but outside the Location information of the S-NSSAI.

If the S-NSSAI is in the Partially Allowed NSSAI, and the UE in CM-IDLE mode is moved to a cell outside the Location information of the S-NSSAI, and the UE has an established PDU Session with that S-NSSAI, the PDU Session is kept.

The Network Slice may be supported in one or more TAs in a PLMN/SNPN. The Partial Network Slice support in a Registration Area for the UE includes configuring the UE with the partially allowed NSSAI and/or S-NSSAI(s) rejected partially in the RA.

Partially Allowed NSSAI: Indicating the S-NSSAIs values the UE could use in the serving PLMN or SNPN in some of the TAs in the current Registration Area. Each S-NSSAI in the Partially Allowed NSSAI is associated with a list of TAs where the S-NSSAI is supported

If received, the S-NSSAI rejected partially in the RA shall be stored in the UE while RM-REGISTERED until the UE moves out of the current Registration Area or until the S-NSSAI is deleted.

Partial Network Slice support in the Registration Area

The network slice may be supported in one or more TAs in the PLMN/SNPN. The Partial Network Slice support in the Registration Area for the UE includes configuring the UE with the Partially Allowed NSSAI and/or S-NSSAI(s) rejected partially in the RA.

Whether the AMF for supporting UEs uses the Partially Allowed NSSAI or rejects the S-NSSAIs partially in the RA is a per S-NSSAI decision which is based on AMF local policy. If supported and allowed by local policy, the Partially Allowed NSSAI and S-NSSAIs rejected partially in the RA may be applied simultaneously for one UE for different S-NSSAIs.

While the S-NSSAIs of the Allowed NSSAI are supported in all the TAs of the Registration Area, the S-NSSAIs of the Partially Allowed NSSAI are supported only in the TAs corresponding to the list of TAs (which are subset of the list of TAIs forming the Registration Area) associated with the S-NSSAI.

If one or more of the requested S-NSSAI(s) are supported in a subset of the TAs of the (potential) Registration Area, the AMF may include such S-NSSAI(s) in the Partially Allowed NSSAI and corresponding mapping information of the S-NSSAI(s) of the Partially Allowed NSSAI to the HPLMN S-NSSAI(s). For each S-NSSAI of the Partially Allowed NSSAI the AMF provides a list of TAs where the S-NSSAI is supported. The UE is considered registered with the S-NSSAI in the whole Registration area. The AMF also provides the Partially Allowed NSSAI (without indication of the TA list where the partially allowed S-NSSAIs are supported) to the NG-RAN together with the UE's context.

Alternatively, the AMF may reject the S-NSSAI(s) with reject cause indicating “partially in the RA”. For each S-NSSAI of the S-NSSAIs rejected partially in the RA the AMF provides a list of TAs for which the S-NSSAI is supported or not supported. When the UE stores Partially Allowed NSSAI the following applies:

The UE is considered registered with an S-NSSAI of the Partially Allowed NSSAI in the whole Registration area. The UE does not trigger registration when moving between the TAs of support and non-support for the S-NSSAI within the RA.

The UE is allowed to initiate PDU Session establishment for the S-NSSAI only when the UE is in a TA where the S-NSSAI is supported.

When the UE has already established a PDU Session with an S-NSSAI part of the Partially Allowed NSSAI, the UE is allowed to activate the User Plane Resources of the PDU Session only when the UE is in a TA part of the list of TAs associated with each S-NSSAI.

When the User Plane Resources are activated for a PDU Session to an S-NSSAI part of the Partially Allowed NSSAI and the UE moves to a TA which is not part of the list of TAs associated with the S-NSSAI, the User Plane Resources for the PDU Session shall be deactivated, but the PDU Session context in UE and SMF is not released. The User Plane Resources for the PDU Session shall not be activated as long as the UE is located in a TA which is not part of the list of TAs associated with the S-NSSAI of the Partially Allowed NSSAI.

When the UE stores the S-NSSAI rejected partially in the RA with the associated list of TAs, the UE is allowed to initiate a Mobility Registration Update procedure to request registration with the S-NSSAI only when the UE is in a TA supporting the S-NSSAI.

Network Slice Area of Service: The area where the UE can access and get service of the particular network slice as more than zero resources are allocated to the network slice in the NG-RAN cells

The network support for the Network Slice is defined on the per Tracking Area granularity. It may be beneficial to deploy some Network Slices such that the Network Slice have a limited geographical availability that is not matching existing Tracking Area boundaries.

The operator can decide to change the topology of the Tracking Areas so they match the boundaries of the Network Slice, or the operator may configure resources for the Network Slices in the cells of TAs where the Network Slices are to be available, and in areas of the TAs where the network slice is defined to be not available the cells are configured with zero resources.

The AMF receives from the OAM the information on availability of the network slice when the granularity is smaller than the TA, i.e. if the NS-AoS includes TAS where the network slice is not available in some cells of the TA.

In order to optimize the end-to-end behavior, the AMF can, based on NS-AoS information received from OAM, configure supporting UEs with S-NSSAI location availability information, and the network may need to monitor the S-NSSAI usage and enforce the NS-AoS e.g. if the UE does not support the S-NSSAI location availability information.

S-NSSAI location availability information defines additional restrictions to the usage of an S-NSSAI in TAs where the Network Slice availability does not match the TA boundaries. The AMF is configured per S-NSSAI whether to send the S-NSSAI location availability information to supporting UEs.

If the UE has indicated that the UE supports S-NSSAI location availability information in the 5GMM Core Network Capability (see clause 5.4.4a), the AMF may, based on OAM configuration, configure the UE with S-NSSAI location availability information for one or more S-NSSAIs when the AMF allocates an RA where the Network Slice availability does not match whole TAs, by including the S-NSSAI location availability information in the Registration Accept message or the UE Configuration Command message. A UE that receives S-NSSAI location availability information applies the information as follows.

If the S-NSSAI is rejected in the RA or rejected partially in the RA or rejected with a cause code that allows attempting to register the S-NSSAI again, the UE can request the S-NSSAI only if the S-NSSAI location availability information indicates that the S-NSSAI is available at the cell where the UE is camping.

If the S-NSSAI is in the Partially Allowed NSSAI, the UE shall not activate User Plane for any already established PDU Session with that S-NSSAI if the UE is in a cell within the RA but outside the Location information of the S-NSSAI.

If the S-NSSAI is in the Partially Allowed NSSAI, and the UE in CM-IDLE mode is moved to a cell outside the Location information of the S-NSSAI, and the UE has an established PDU Session with that S-NSSAI, the PDU Session is kept.

In an embodiment, the network based monitoring and enforcement of Network Slice Area of Service not matching deployed Tracking Areas

The OAM may configure RRM policies for S-NSSAIs on a per cell basis as defined in TS 28.541. That is cells outside the Network Slice Area of Service while in a TA supporting the S-NSSAI are allocated with no RRM resources for the S-NSSAI.

The network may enforce the NS-AoS for an S-NSSAI as follows:
1. The network monitors the validity of the S-NSSAI for UE in CM-CONNECTED state, i.e. as per the location.
2. If the UE makes a PDU Session establishment request or user plane resources establishment request with an S-NSSAI for e.g. in service request message using uplink data status IE that is not valid as per the S-NSSAI location availability information, the AMF may reject the NAS message with a back-off timer using S-NSSAI based congestion control.
3. If the AMF determines that the UE in CM-CONNECTED has moved outside the NS-AoS, the AMF performs the following logic:
a) If the non-supporting UE has other S-NSSAI(s) in the Allowed NSSAI, then the AMF may update the UE with a UE Configuration Update by removing the S-NSSAI from the Allowed NSSAI (which causes the UE to locally release the PDU Sessions) and removing the S-NSSAI from the Configured NSSAI, and then the AMF requests the SMF to locally release in the network any PDU Sessions with that S-NSSAI as per step 1f in clause 4.2.3.4 in TS 23.502.
b) If the non-supporting UE does not have any other S-NSSAI in the Allowed NSSAI, then the AMF may update the UE with a UE Configuration Update by removing the S-NSSAI from the Allowed NSSAI (which causes the UE to locally release the PDU Sessions) and removing the S-NSSAI from the Configured NSSAI, and adding a default S-NSSAI to the Allowed NSSAI, and then the AMF requests the SMF to locally release in the network any PDU Sessions with the removed S-NSSAI as per step 1f in clause 4.2.3.4 in TS 23.502.
c) For a non-supporting UE that does not have any other S-NSSAI in the Allowed NSSAI nor in the Configured NSSAI, then the AMF indicates to the SMF to release the PDU Session.
4. If the AMF determines that the S-NSSAI becomes valid e.g. the UE has moved into the NS-AoS, the AMF updates the UE with a UCU e.g. including the S-NSSAI in the Configured NSSAI.

The network slice may be available for all UEs or a limited number of UEs only for a limited time that is known at the network in advance e.g. by OAM or subscription. The limited time duration may be due to, for example, the fact that network slice is only temporarily or periodically active in the deployment (e.g. for a limited time to serve an event or a UE may be only authorized to access the network slice for a limited time known in advance), or the network slice is being decommissioned at a known future time. This feature is enabled by S-NSSAI validity time that the network and the UE can handle to reduce the signaling load associated to the transitions in RM and SM states for the network slice.

The UE may indicate its support for temporarily available network slices in the UE MM Core Network Capability (see clause 5.4.4a) in the Registration Request. The AMF, based on OAM configuration or information received from a Unified Data Management (UDM) or NSSF, may indicate to a supporting UE the validity time for one or more S-NSSAIs in the Configured NSSAI in the Registration Accept message or via the UE Configuration Update procedure. In roaming case, the AMF may include the validity time for an S-NSSAI in the Configured NSSAI either because of limited availability of the VPLMN S-NSSAI or the mapped S-NSSAI of a Home PLMN (HPLMN).

If a supporting UE is configured with validity time for an S-NSSAI:
a) If the validity time indicates the S-NSSAI is available, the UE may request the S-NSSAI in a Requested NSSAI in a Registration request and, if the S-NSSAI is included in the Allowed NSSAI or in the Partially Allowed NSSAI, the UE may establish PDU sessions associated with the S-NSSAI.
b) If the validity time indicates the S-NSSAI is not available.
a) The UE shall not include the S-NSSAI in the Requested NSSAI;
b) If the S-NSSAI is already part of the Allowed NSSAI or Partially Allowed NSSAI, the UE removes the S-NSSAI from the locally stored Allowed NSSAI or Partially Allowed NSSAI and the UE also locally releases any PDU sessions associated with the S-NSSAI.
c) If the validity time indicates the S-NSSAI will not be available again, the UE removes the S-NSSAI from the locally stored Configured NSSAI.

For a supporting UE, if validity time applies to the S-NSSAI, the AMF supporting temporarily available network slices shall:
1. If the S-NSSAI is provided in a Requested NSSAI in a Registration Request by the UE and the validity time indicates the S-NSSAI is not available, but it is going to become available again (i.e. the UE is detected as not having up to date validity time), then the AMF sends the Configured NSSAI to the UE including the validity time for the S-NSSAI in the Registration Accept message. If the validity time indicates the S-NSSAI is not available and will not become available again, then the AMF sends the Configured NSSAI to the UE, excluding the S-NSSAI from the Configured NSSAI.
2. If the S-NSSAI is in the Allowed NSSAI or the Partially Allowed NSSAI for the UE and the validity time indicates that the S-NSSAI is not available, then locally remove (i.e. without sending any signalling to the UE) the S-NSSAI from the Allowed NSSAI or Partially Allowed NSSAI. If there is any PDU session established for the S-NSSAI, the AMF requests the SMF to release the PDU session:
3. If the UE is in CM-CONNECTED state, the AMF releases the PDU session for the S-NSSAI by sending to the SMF, as per step 1f in clause 4.3.4.2 of TS 23.502, a Nsmf_PDUSession_UpdateSMContext Request with a release indication to request the release of the PDU Session and then the AMF forwards the N2 SM request to release the AN resources associated with the PDU session
4. If the UE is in CM-IDLE state, the AMF locally releases the PDU session without paging the UE and causes the SMF to locally release the SM context for the UE by a Nsmf_PDUSession_ReleaseSMContext, as in step 1c in clause 4.3.4.2 of TS 23.502. The PDU Session status is synchronized at next time when the UE connects to the network.

For a non-supporting UE, if validity time applies to an S-NSSAI, an AMF supporting temporarily available network slices shall:
1. If the validity time indicates the S-NSSAI is available, allow or partially allow the network slice when requested, establish PDU sessions when requested.
2. If the S-NSSAI is provided in a Requested NSSAI in a Registration Request by the UE and the validity time indicates the S-NSSAI is not available, reject the registration and remove the S-NSSAI from the Configured NSSAI by providing an updated Configured NSSAI in the Registration Accept message.
3. If the S-NSSAI is in the UE in the Allowed NSSAI or Partially Allowed NSSAI and the validity time indicates the S-NSSAI is not available, remove the S-NSSAI from the Configured NSSAI and the Allowed NSSAI or Partially Allowed NSSAI by a UE Configuration Update procedure. If there is any PDU session established for the S-NSSAI, the AMF requests the SMF to release the PDU session in the network:
4. If the UE is in CM-CONNECTED state, the AMF releases the PDU session for the S-NSSAI by sending to the SMF, as in step 1f in clause 4.3.4.2 of TS 23.502, a Nsmf_PDUSession_UpdateSMContext Request with a release indication to request the release of the PDU Session and then the AMF forwards the N2 SM request to release the AN resources associated with the PDU session.
5. If the UE is in CM-IDLE, the AMF locally releases the PDU session without paging the UE and causes the SMF to locally release the SM context for the UE by a Nsmf_PDUSession_ReleaseSMContext, as in step 1c in clause 4.3.4.2 of TS 23.502. The PDU Session status is synchronized at next time when the UE connects to the network.

If the AMF detects from the validity time of a S-NSSAI that it is available again, then update the Configured NSSAI to include the S-NSSAI via a UE Configuration Update procedure.

Below are list of UL NAS message
1. Authentication failure
2. Authentication response
3. Registration request
4. Registration complete
5. UL NAS transport
6. De-registration request
7. De-registration accept
8. Service request
9. Configuration update complete
10. Identity response
11. Notification response
12. Security mode complete
13. Security mode reject
14. Security protected 5GS NAS message
15. 5GMM status
16. Control Plane Service request
17. Network slice-specific authentication complete
18. Relay key request
19. Relay authentication response
20. PDU session establishment request
21. PDU session authentication complete
22. PDU session modification request
23. PDU session modification complete
24. PDU session modification command reject
25. PDU session release request
26. PDU session release complete
27. 5GSM status
28. Service-level authentication complete
29. Remote UE report

Below are list of DL NAS message
1. Authentication request
2. Authentication result
3. Authentication reject
4. Registration accept
5. Registration reject
6. DL NAS transport
7. De-registration accept
8. Service accept
9. Service Reject
10. Configuration update command
11. Identity request
12. Notification
13. Security mode command
14. Security protected 5GS NAS message
15. 5GMM status
16. Network slice-specific authentication command
17. Network slice-specific authentication result
18. Relay key accept
19. Relay key reject
20. Relay authentication request
21. PDU session establishment accept
22. PDU session establishment reject
23. PDU session authentication command
24. PDU session authentication result
25. PDU session modification reject
26. PDU session modification command
27. PDU session release reject
28. PDU session release command
29. 5GSM status
30. Service-level authentication command
31. Remote UE report response

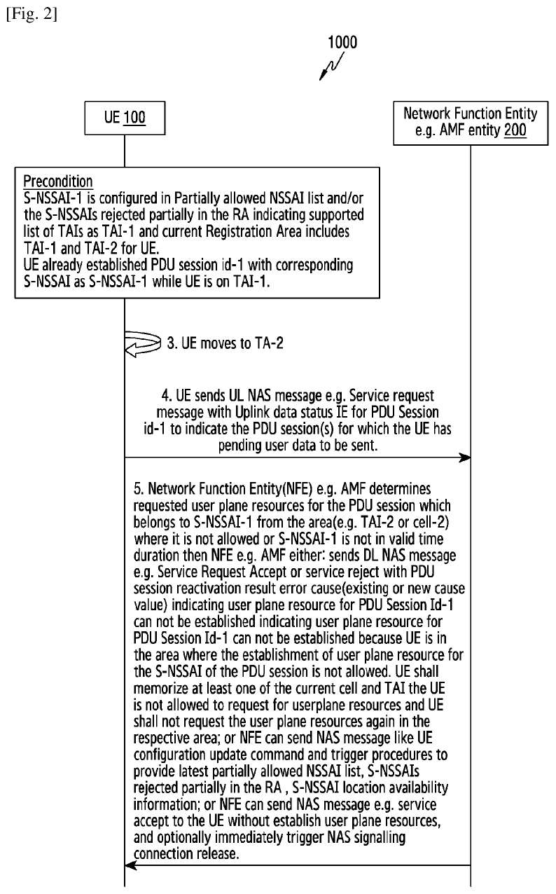

Referring now to the drawings and more particularly to FIGS. 2 through 8, where similar reference characters denote corresponding features consistently throughout the figures, there are shown preferred embodiments.

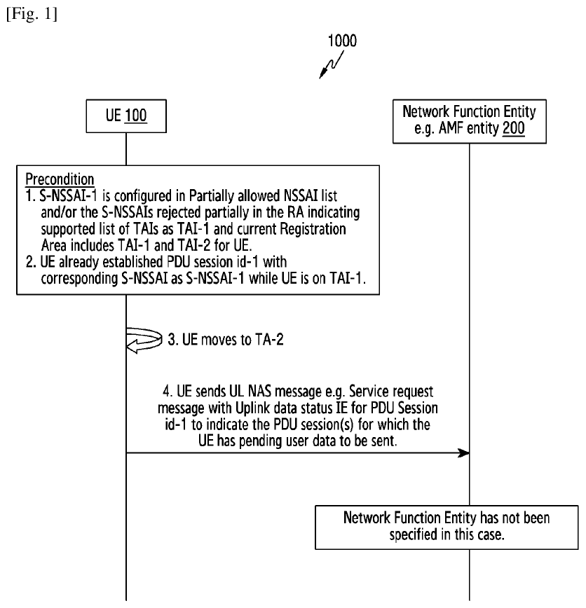

FIG. 1 is a sequence diagram of a UE (100) sending a service request to an AMF entity (200) in a non-supported area in a wireless network (1000), according to a prior art.

Precondition: At step 1, S-NSSAI-1 is configured in a partially allowed NSSAI list and/or the S-NSSAIs rejected partially in a Registration Area (RA) indicating supported list of TAIs as TAI-1 and a current registration area includes TAI-1 and TAI-2 for the UE (100). At step 2, the UE (100) is already established PDU session id-1 with a corresponding S-NSSAI as the S-NSSAI-1 while the UE (100) is on the TAI-1.

In conventional method, at step 3, the UE (100) moves to a TAI-2. At step 4, the UE (100) sends an UL NAS message e.g. service request message with uplink data status IE for PDU Session id-1 to indicate the PDU session(s) for which the UE (100) has pending user data to be sent. The network entity action has not been specified in the conventional method.

FIG. 2 is a sequence diagram illustrating a network entity (e.g., AMF entity (200)) sending the reject with cause, according to the embodiments disclosed herein.

Precondition: At step 1, the S-NSSAI-1 is configured in Partially allowed NSSAI list and/or the S-NSSAIs rejected partially in the RA indicating supported list of TAIs as TAI-1 and current Registration Area includes TAI-1 and TAI-2 for the UE (100). S-NSSAI-1 is not supported over TAI-1. Also, the UE (100) is configured with the S-NSSAI location availability information indicating that cell-1 supports S-NSSAI-1 and S-NSSAI-1 is not supported on cell-2. At step 2, the UE (100) already established PDU session id-1 with corresponding S-NSSAI as S-NSSAI-1 while the UE (100) is on TAI-1 or cell-1.

At step 3, the UE (100) moves to the TAI-2 or cell-2. At step 4, the UE (100) sends UL NAS message e.g. Service request message with Uplink data status IE for PDU Session id-1 to indicate the PDU session(s) for which the UE has pending user data to be sent.

At step 5, the Network Function Entity (NFE) e.g. AMF entity (200) determines requested user plane resources for the PDU session which belongs to S-NSSAI-1 from the area (e.g. TAI-2 or cell-2) where it is not allowed/supported or S-NSSAI-1 is not in valid time duration in the AMF entity (200).

In an embodiment, the AMF entity (200) sends the DL NAS message e.g. Service Request Accept or service reject with PDU session reactivation result error cause (existing or new cause value) indicating user plane resource for PDU Session Id-1 cannot be established indicating user plane resource for PDU Session Id-1 cannot be established because the UE (100) is in the area (in the Cell or TAI) where the establishment of user plane resource for the S-NSSAI of the PDU session is not allowed. The UE (100) memorizes at least one of the current cell and TAI the UE (200) is not allowed to request for user-plane resources and the UE (100) shall not request the user plane resources again, the reject cause can be separate for cell, TAI or not valid duration indication, if reject cause indicates the UE (100) is not allowed for the cell, then the UE (100) shall not request user-plane resources in that cell. Further, the UE (100) treats as if the current cell is in the S-NSSAI location availability information indicating cell is not allowed for that S-NSSAI, or the UE (100) can add or remove current cell info (like cell ID etc) into S-NSSAI location availability information indicating cell is not allowed for that S-NSSAI. Similarly, if the reject cause indicates the UE (100) is not allowed for the TAI, then the UE (100) does not request user-plane resources in that TAI, the UE (100) treats as if the current TAI is in the Partially allowed NSSAI list and/or the S-NSSAIs rejected partially in the RA indicating current TAI is not allowed for that S-NSSAI or the UE (100) can add/ remove current TAI into Partially allowed NSSAI list and/or the S-NSSAIs rejected partially in the RA indicating no supported/not available for respective S-NSSAI. If the reject cause indicates S-NSSAI is not valid in the duration, the UE (100) should not request the user plane resources on the PDU session of that respective S-NSSAI for that duration (i.e. the UE (100) would back off to request user plane resources of the PDU session of that respective S-NSSAI). The duration can be explicitly indicated by the network (i.e. based on the network determination) or locally calculated by the UE (i.e. based on the UE determination). Additionally, the UE (100) can remove the S-NSSAI from the allowed NSSAI list or Partially allowed NSSAI list or if the configuration indicates the S-NSSAI will not be used again then S-NSSAI can be removed from the configured NSSAI list. The terms S-NSSAI and S-NSSAI-1 are used interchangeably and have same meaning.

Network Function Entity (NFE) e.g. AMF entity (200), determines requested user plane resources for the PDU session which belongs to S-NSSAI-1 from the area (e.g. TAI-2 or cell-2) where it is not allowed or S-NSSAI-1 is not in valid time duration in NFE e.g. AMF entity (200).

In another embodiment, the NFE can send NAS message like UE configuration update command and trigger procedures to provide latest partially allowed NSSAI list, S-NSSAIs rejected partially in the RA, S-NSSAI location availability information.

That is, the AMF entity (200) will send the UE configuration update command of UE CONFIGURATION update procedure including latest partially allowed NSSAI list (optionally if the UE (100) has attempted from not supported TAI), S-NSSAIs rejected partially in the RA (optionally if the UE (100) has attempted from not supported TAI), S-NSSAI location availability information(optionally if the UE (100) has attempted from not supported cell), Time validity information of the S-NSSAI optionally if the UE (100) has attempted user plane resource establishment during the time interval when it is not allowed to.

The network Function Entity (NFE) e.g. AMF entity (200), determines requested user plane resources for the PDU session which belongs to S-NSSAI-1 from the area (e.g. TAI-2 or cell-2) where it is not allowed or S-NSSAI-1 is not in valid time duration in NFE e.g. AMF entity (200). In another embodiment, the NFE can send NAS message e.g. service accept, to the UE (100) without establish user plane resources, and optionally immediately trigger NAS signalling connection release.

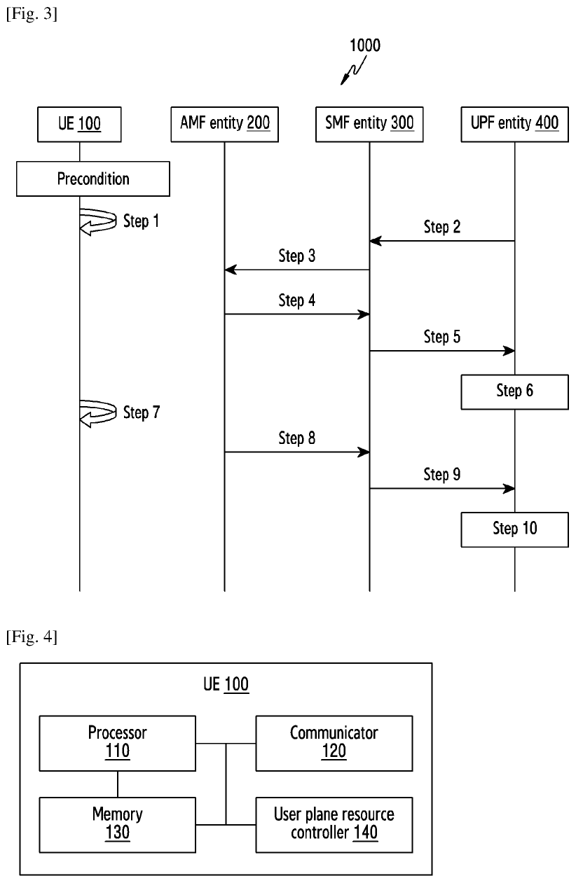

FIG. 3 is a sequence diagram various scenarios of a downlink data handling in the non-supported area in a connected mode (CM) in a wireless network (1000), according to the embodiments disclosed herein.

Precondition: The S-NSSAI-1 is configured in the Partially allowed NSSAI list and/or the S-NSSAIs rejected partially in the RA indicating supported list of TAIs as TAI-1 and current Registration Area includes TAI-1 and TAI-2 for the UE (100). The UE (100) is already established PDU session id-1 with corresponding S-NSSAI as S-NSSAI-1 while the UE (100) is on TAI-1. The UE (100) is in the 5GMM-CONNECTED state.

In an embodiment, at step 1, the UE (100) moves to TAI-2 or cell which does not support the S-NSSAI-1 or current time not falls under validity time for the S-NSSAI-1.

At step 2, the network function entity e.g. UPF entity (400), receives downlink data packets for the PDU Session id-1 and the Network Function Entity e.g. UPF entity (400) sends data notification to another network function entity e.g. the SMF entity (300).

At step 3, the Network Function Entity e.g. SMF entity (300), may request another Network Function Entity e.g. AMF entity (200) in the message. In an example, the SMF entity (300) invokes the Namf_Communication_N1N2MessageTransfer service operation containing N2 SM Information to determine if the UE (100) is currently inside of supported tracking area or Network Slice Area of Service or outside of validity timer (for temporary Network Slice) for current S-NSSAI i.e. S-NSSAI-1. Optionally The network Function Entity e.g. SMF entity (300) may also determine whether the UE (100) is currently inside of supported tracking area or Network Slice Area of Service or outside of validity timer (for temporary Network Slice) for current S-NSSAI i.e. S-NSSAI-1.

At step 4, If the UE (100) is in IDLE mode, the AMF entity (200), determines the location of the UE (100) for e.g. by sending paging message to the UE (100) or by querying the UE location from a RAN. Receiving the N2 message carrying the UE location information. If the UE (100) is in the CM-IDLE mode, the network Function Entity e.g. AMF entity (200), pages the UE (100) and determines that that the UE (100) is non supported TAI then the AMF entity (200) may follow one or more below procedure:
1) Sends DL NAS message e.g. service reject to the UE (100).
2) Sends DL NAS message e.g. service accept message without establishing user plane resources of the PDU session+S-NSSAI combination that is not allowed in the area(TAI/cell).
3) May optionally initiate for RRC connection release.
4) May reject any MT data as described in below solution.
5) Optionally Network Function Entity may page only in supported S-NSSAI if no response from the UE (100) then network will reject the MT data.

If the UE (100) is in the connected mode, the Network Function Entity e.g. AMF entity (200), may determine if the UE (100) in supported or non-supported area (e.g. TAI/cell) or in S-NSSAI is in validity time for e.g. by sending an N2 Request to the (R)AN or based on indication from (R)AN node i.e. N2 Response carrying the ULI information.

Upon determining UE's location/time validity Network Function Entity e.g. AMF entity (200) may send message e.g. Nsmf_PDUSession_UpdateSMContext request message to notify the SMF entity (300) that the UE (100) is currently outside of supported tracking area or Network Slice Area of Service or outside of validity timer (for temporary Network Slice) for current S-NSSAI i.e. S-NSSAI-1.

At step 5, the Network Function Entity e.g. SMF entity (300), may sends message e.g. N4 Session Modification Request to another Network Function Entity e.g. UPF entity (400), with indication that the UE (100) is outside of supported tracking area or Network Slice Area of Service or outside of validity timer (for temporary Network Slice) for current S-NSSAI i.e. S-NSSAI-1.

At step 6, Network Function entity e.g. UPF entity (400) may decide to either discard or buffer the data packets and deactivate user plane recourses(i.e. suspend data transmission) for corresponding PDU Session id-1 if user plane recourses has not been deactivated yet. Optionally Network Function Entity e.g. SMF entity (300)/AMF entity (200)/UPF entity (400) may send NAS message e.g. PDU Session release request to the UE (100) or optionally locally releases the PDU Session or block the data by disabling the downlink data notifications/by not sending the data over the NAS message.

Precondition: In another embodiment, S-NSSAI-1 is configured in the partially allowed NSSAI list and/or the S-NSSAIs rejected partially in the RA indicating supported list of TAIs as TAI-1 and current Registration Area includes TAI-1 and TAI-2 for the UE (100). The UE (100) is already established PDU session id-1 with corresponding S-NSSAI as S-NSSAI-1 while the UE (100) is on TAI-1.

In an embodiment, the Network Function Entity e.g. SMF entity (300) may sends message e.g. N4 Session Modification Request to another Network Function Entity e.g. UPF entity (400) with indication that the UE (100) is outside of supported tracking area or Network Slice Area of Service or outside of validity timer (for temporary Network Slice) for current S-NSSAI i.e. S-NSSAI-1. Optionally, this step can be after the SMF entity (300) determining by itself the UE (100) is outside of supported tracking area or Network Slice Area of Service or outside of validity timer (for temporary Network Slice) for current S-NSSAI i.e. S-NSSAI-1.

In an embodiment, the Network Function entity e.g. UPF entity (400) or SMF entity (300), may decide to either discard or buffer the data packets and deactivate user plane recourses(i.e. suspend any further data sending or receiving) for corresponding PDU Session id-1 of the UE (100) if user plane recourses has not been deactivated yet. Optionally Network Function Entity e.g. SMF entity (300)/AMF entity (200)/UPF entity (400) may send NAS message e.g. PDU Session release request to the UE (100) and release respective PDU session or optionally locally releases the PDU Session.

In an embodiment, the Network Function Entity e.g. AMF entity (200) or SMF entity (300) determines the UE (100) moves to TAI-1 and/or cell supporting the S-NSSAI and/or current time falls inside the validity time of the S-NSSAI.

In an embodiment, at step 8, the Network Function Entity e.g. AMF entity (200) may send message e.g. Nsmf_PDUSession_UpdateSMContext request message to notify the SMF entity (300) that the UE (100) is currently inside of supported tracking area or Network Slice Area of Service or inside of validity timer (for temporary Network Slice) for current S-NSSAI i.e. S-NSSAI-1. Optionally Network Function Entity e.g. SMF entity (300) may also determine whether the UE (100) moves inside the supported tracking area or Network Slice Area of Service or inside of validity timer (for temporary Network Slice) for current S-NSSAI i.e. S-NSSAI-1.

In an embodiment, at step 9, the Network Function Entity e.g. SMF entity (300) may sends message e.g. N4 Session Modification Request to another Network Function Entity e.g. UPF entity (400) with indication that the UE (100) is inside of supported tracking area or Network Slice Area of Service or inside of validity timer (for temporary Network Slice) for current S-NSSAI i.e. S-NSSAI-1.

In an embodiment, at step 10, the Network Function entity e.g. UPF entity (400) or SMF entity (300) may decide to activate user plane resources(i.e. resume sending or receiving data) of PDU Session i.e. PDU Session id-1 if user plane resources of PDU session id-1 was deactivated/suspended earlier. After, the UPF entity (400) may send all downlink data packets to the UE (100) of the PDU session of S-NSSAI-1.

An EPS in the embodiment can also be referred to S1-mode or E-UTRAN or LTE system. 5GS in the embodiment can also be referred to N1-mode or NR or NG-RAN or 5G.

FIG. 4 shows various hardware components of the UE (100), according to the embodiments as disclosed herein. The UE (100) may be but not limited to a laptop, a desktop, a mobile phone, a smart phone, Personal Digital Assistant (PDA), a tablet, a wearable device, an Internet of Things (IoT) device, a virtual reality device, Video see through (VST), an Augmented reality (AR) glass, a foldable device, a flexible device, a display device and an immersive system. In an embodiment, the UE (100) includes a processor (110), a communicator (120), a memory (130) and a user plane resource controller (140). The processor (110) is coupled with the communicator (120), the memory (130) and the user plane resource controller (140).

The user plane resource controller (140) requests to establish the user plane resource in the uplink data status IE for the PDU session. Further, the user plane resource controller (140) receives the NAS message from the AMF entity (200). The NAS message indicates the cause to the UE (100) that the UP resources establishment has failed due to the non-supported area of the S-NSSAI. The NAS message is one of the service accept message or the registration accept message. The service accept message or the registration accept message includes the PDU session reactivation result IE. The PDU session reactivation result IE indicates the cause to the UE (100) that the UP resources establishment has failed due to the non-supported area. Further, the user plane resource controller (140) stops to attempt to the request for the user plane resource in the non-supported area for the PDU session of the S-NSSAI. In an embodiment, stopping to attempt to request for the user plane resources is for certain duration of time, wherein the certain duration is calculated by the UE (100) based on implementation or indicated by a network along with the cause in the NAS message.

The user plane resource controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In an embodiment, the communicator (120) includes an electronic circuit specific to a standard that enables wired or wireless communication. The communicator (120) is configured to communicate internally between internal hardware components of the UE (100) and with external devices via one or more networks.

Although the FIG. 4 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

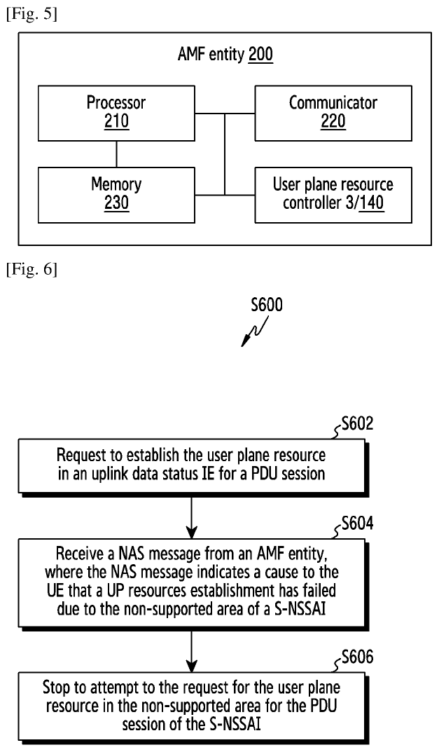

FIG. 5 shows various hardware components of the AMF entity (200), according to the embodiments as disclosed herein. In an embodiment, the AMF entity (200) includes a processor (210), a communicator (220), a memory (230) and a user plane resource controller (240). The processor (210) is coupled with the communicator (220), the memory (230) and the user plane resource controller (240).

The user plane resource controller (240) sends the NAS message to the UE (100). The NAS message indicates the cause to the UE (100) that the UP resources establishment has failed due to the non-supported area of the S-NSSAI, when the UE (100) requests to establish the user plane resource in the uplink data status IE for the PDU session. The NAS message is one of the service accept message or the registration accept message. The service accept message or the registration accept message includes the PDU session reactivation result IE. The PDU session reactivation result IE indicates the cause to the UE (100) that the UP resources establishment has failed due to the non-supported area. Based on the NAS message, the user plane resource controller (240) handles the user plane resource in the non-supported area.

Further, the user plane resource controller (240) determines that the UE (100) is in the non-supported area for the PDU session for the S-NSSAI when the UE (100) is not inside the NS-AoS of the S-NSSAI of the PDU session or the UE (100) is the TAI which does not support the S-NSSAI of the PDU session based on Partially allowed NSSAI list or S-NSSAIs rejected partially in a Routing Area (RA).

In another embodiment, the user plane resource controller (240) determines whether the UE (100) is in the allowed area for the S-NSSAI or not in the allowed area for the S-NSSAI from the network node (e.g., NG-RAN node). In an embodiment, the user plane resource controller (240) indicates to the SMF entity (300) that the UE (100) is not in an allowed area for the S-NSSAI when the UE (100) moves out of the allowed area for the S-NSSAI. The SMF entity (300) blocks the data by disabling the data notification or release of the PDU session of that S-NSSAI or by not sending user data as payload of NAS message to the UE (100).

In another embodiment, the user plane resource controller (240) indicates to the SMF entity (300) that the UE (100) is in the allowed area for the S-NSSAI when the UE (100) moves inside the allowed area for the S-NSSAI. The SMF entity (300) starts sending the data or receiving the data.

Further, the user plane resource controller (240) determines that the UE (100) is in the allowed area or not allowed area using the user location information received in the N2 message from the network node.

Further, the user plane resource controller (240) determines that UE (100) is in the allowed area or not allowed area by creating the area of interest and indicating to the network node, and receiving the information on the UE location from the network node based on the indicated Area of interest.

Further, the user plane resource controller (240) determines that the UE (100) is in the allowed area or not in the allowed area based on the NS-AoS, the Partially allowed NSSAI list or the S-NSSAIs rejected partially in the RA.

The user plane resource controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (230).

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

In an embodiment, the communicator (220) includes an electronic circuit specific to a standard that enables wired or wireless communication. The communicator (220) is configured to communicate internally between internal hardware components of the UE (100) and with external devices via one or more networks.

Although the FIG. 5 shows various hardware components of the AMF entity (200) but it is to be understood that other embodiments are not limited thereon. In other embodiments, the AMF entity (200) may include less or more number of components. Further, the labels or names of the components are used only for illustrative purpose and does not limit the scope of the invention. One or more components can be combined together to perform same or substantially similar function in the AMF entity (200).

In addition, the description regarding FIG. 5 can be applied to the SMF entity with appropriate modifications according to smf operation.

FIG. 6 is a flow chart (S600) illustrating a method, implemented by the UE (100), for handling the user plane resource in the non-supported area, according to the embodiments as disclosed herein. The operations (S602-S606) are handled by the user plane resource controller (140).

At S602, the method includes requesting to establish the user plane resource in the uplink data status IE for the PDU session. At S604, the method includes receiving the NAS message from the AMF entity (200). The NAS message indicates the cause to the UE (100) that the UP resources establishment has failed due to the non-supported area of the S-NSSAI. At S606, the method includes stopping to attempt to the request for the user plane resource in the non-supported area for the PDU session of the S-NSSAI.

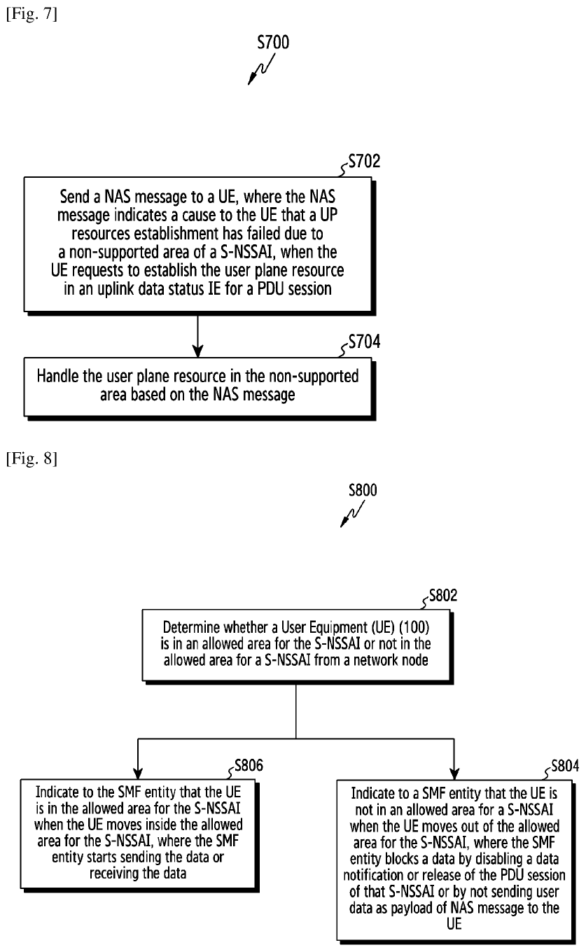

FIG. 7 and FIG. 8 are flow charts (S700 and S800) illustrating a method, implemented by the AMF entity (200), for handling the user plane resource in the non-supported area, according to the embodiments as disclosed herein.

As shown in FIG. 7, the operations (S702 and S704) are handled by the user plane resource controller (240). At S702, the method includes sending the NAS message to the UE (100). The NAS message indicates the cause to the UE (100) that the UP resources establishment has failed due to the non-supported area of the S-NSSAI, when the UE (100) requests to establish the user plane resource in the uplink data status IE for the PDU session. At S704, the method includes handling the user plane resource in the non-supported area based on the NAS message.

As shown in FIG. 8, the operations (S802-S806) are handled by the user plane resource controller (240). At S802, the method includes determining whether the UE (100) is in the allowed area for the S-NSSAI or not in the allowed area for the S-NSSAI from the network node. At S804, the method includes indicating to the SMF entity (300) that the UE (100) is not in the allowed area for the S-NSSAI when the UE (100) moves out of the allowed area for the S-NSSAI. The SMF entity (300) blocks the data by disabling the data notification or release of the PDU session of that S-NSSAI or by not sending user data as payload of NAS message to the UE (100). At S806, the method includes indicating to the SMF entity (300) that the UE (100) is in the allowed area for the S-NSSAI when the UE (100) moves inside the allowed area for the S-NSSAI, wherein the SMF entity (300) starts sending the data or receiving the data.

In an embodiment of the present disclosure, a method for handling a user plane resource in a non-supported area, comprising: requesting, by a User Equipment (UE) (100), to establish the user plane resource in an uplink data status information element (IE) for a Protocol Data Unit (PDU) session; receiving, by the UE (100), a Non-access stratum (NAS) message from an Access and Mobility Management Function (AMF) entity (200), wherein the NAS message indicates a cause to the UE (100) that a uplink (UP) resources establishment has failed due to the non-supported area of a Single-Network Slice Selection Assistance Information (S-NSSAI); and stopping, by the UE (100), to attempt to the request for the user plane resource in the non-supported area for the PDU session of the S-NSSAI.

In an embodiment of the present disclosure, wherein stopping to attempt to request for the user plane resources is for certain duration of time, wherein the certain duration is calculated by the UE (100) based on implementation or indicated by a network along with the cause in the NAS message.

In an embodiment of the present disclosure, wherein the NAS message is one of a service accept message or a registration accept message, wherein the service accept message or the registration accept message comprises the PDU session reactivation result information element (IE), wherein the PDU session reactivation result IE indicates a cause to the UE (100) that the UP resources establishment has failed due to the non-supported area.

In an embodiment of the present disclosure, wherein the AMF entity (200) determines that the UE (100) is in the non-supported area for the PDU session for the S-NSSAI when the UE (100) is not inside a network slice area of service (NS-AoS) of the S-NSSAI of the PDU session or the UE (100) is a Tracking Area Identity (TAI) which does not support the S-NSSAI of the PDU session based on a Partially allowed NSSAI list or S-NSSAIs rejected partially in a Routing Area (RA).

In an embodiment of the present disclosure, a method for handling a user plane resource in a non-supported area, comprising: sending, by an Access and Mobility Management Function (AMF) entity (200), a NAS message to a User Equipment (UE) (100), wherein the NAS message indicates a cause to the UE (100) that a uplink (UP) resources establishment has failed due to a non-supported area of a S-NSSAI, when the UE (100) requests to establish the user plane resource in an uplink data status information element (IE) for a Protocol Data Unit (PDU) session; and handling, by the AMF entity (200), the user plane resource in the non-supported area based on the NAS message.

In an embodiment of the present disclosure, wherein the NAS message is one of a service accept message or a registration accept message, wherein the service accept message or the registration accept message comprises a PDU session reactivation result IE, wherein the PDU session reactivation result IE indicates a cause to the UE that the UP resources establishment has failed due to the non-supported area.

In an embodiment of the present disclosure, wherein the AMF entity (200) determines that the UE (100) is in a non-supported area for the PDU session for the S-NSSAI when the UE (100) is not inside a network slice area of service (NS-AoS) of the S-NSSAI of the PDU session or the UE (100) is the TAI which does not support the S-NSSAI of the PDU session based on Partially allowed NSSAI list or S-NSSAIs rejected partially in a Routing Area (RA).

In an embodiment of the present disclosure, a method for handling a user plane resource in a non-supported area, comprising: determining, by an Access and Mobility Management Function (AMF) entity (200), whether a User Equipment (UE) (100) is in an allowed area for the S-NSSAI or not in the allowed area for a S-NSSAI from a network node; and performing, by the AMF entity (200), one of: indicating to a Session Management Function (SMF) entity (300) that the UE (100) is not in an allowed area for a Single-Network Slice Selection Assistance Information (S-NSSAI) when the UE (100) moves out of the allowed area for the S-NSSAI, wherein the SMF entity (300) blocks a data by disabling a data notification or release of the PDU session of that S-NSSAI or by not sending user data as payload of NAS message to the UE (100), and indicating to the SMF entity (300) that the UE (100) is in the allowed area for the S-NSSAI when the UE (100) moves inside the allowed area for the S-NSSAI, wherein the SMF entity (300) starts sending the data or receiving the data.

In an embodiment of the present disclosure, wherein the AMF entity (200) determines that the UE (100) is in the allowed area or not allowed area using a user location information received in a N2 message from the network node.

In an embodiment of the present disclosure, wherein the AMF entity (200) determines that UE (100) is in the allowed area or not allowed area by creating an area of interest and indicating to the network node, and receiving the information on the UE location from the network node based on the indicated Area of interest.

In an embodiment of the present disclosure, wherein the AMF entity (200) determines that the UE (100) is in the allowed area or not in the allowed area based on the network slice area of service (NS-AoS), a Partially allowed NSSAI list or S-NSSAIs rejected partially in the RA.

In an embodiment of the present disclosure, wherein the SMF entity (300) registers with the AMF entity (200) by indicating the S-NSSAI to determine if the UE (100) is in the allowed area or not in the allowed area of a respective S-NSSAI.

In an embodiment of the present disclosure, wherein the network node is a NG-RAN node.

In an embodiment of the present disclosure, a UE (100) for handling a user plane resource in a non-supported area, comprising: a memory (130); a processor (110); and a user plane resource controller (140), communicatively coupled to the memory (130) and the processor (110), configured to: request to establish the user plane resource in an uplink data status information element (IE) for a Protocol Data Unit (PDU) session; receive a Non-access stratum (NAS) message from an Access and Mobility Management Function (AMF) entity (200), wherein the NAS message indicates a cause to the UE (100) that a uplink (UP) resources establishment has failed due to the non-supported area of a Single-Network Slice Selection Assistance Information (S-NSSAI); and stop to attempt to the request for the user plane resource in the non-supported area for the PDU session of the S-NSSAI.

In an embodiment of the present disclosure, an AMF entity (200) for handling a user plane resource in a non-supported area, comprising: a memory (230); a processor (210); and a user plane resource controller (240), communicatively coupled to the memory (230) and the processor (210), configured to: send a NAS message to a User Equipment (UE) (100), wherein the NAS message indicates a cause to the UE (100) that a uplink (UP) resources establishment has failed due to a non-supported area of a S-NSSAI, when the UE (100) requests to establish the user plane resource in an uplink data status information element (IE) for a Protocol Data Unit (PDU) session; and handle the user plane resource in the non-supported area based on the NAS message.

In an embodiment of the present disclosure, an AMF entity (200) for handling a user plane resource in a non-supported area, comprising: a memory (230); a processor (210); and a user plane resource controller (240), communicatively coupled to the memory (230) and the processor (210), configured to: determine whether a User Equipment (UE) (100) is in an allowed area for the S-NSSAI or not in the allowed area for a S-NSSAI from a network node; and perform one of: indicate to a Session Management Function (SMF) entity (300) that the UE (100) is not in an allowed area for a Single-Network Slice Selection Assistance Information (S-NSSAI) when the UE (100) moves out of the allowed area for the S-NSSAI, wherein the SMF entity (300) blocks a data by disabling a data notification or release of the PDU session of that S-NSSAI or by not sending user data as payload of NAS message to the UE (100), and indicate to the SMF entity (300) that the UE (100) is in the allowed area for the S-NSSAI when the UE (100) moves inside the allowed area for the S-NSSAI, wherein the SMF entity (300) starts sending the data or receiving the data.

The various actions, acts, blocks, steps, or the like in the flow charts (S600-S800) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by an access management function (AMF) entity in a wireless communication system, the method comprising:
receiving, from a session management function (SMF) entity, single network slice selection assistance information (S-NSSAI) for requesting the AMF entity to report whether a user equipment (UE) is present in a first area;
determining whether the UE is present in the first area; and
transmitting, to the SMF entity, a notification of whether the UE is present in the first area, based on the S-NSSAI,
wherein, in case that the UE is not inside-present in the first area, downlink user data is not transmitted-.

2. The method of claim 1, wherein, in case that the UE is not present in the first area:
a protocol data unit (PDU) session is deactivated, and
user plane resources associated the PDU session is released.

3. The method of claim 1, wherein the determining whether the UE is present in the first area is based on UE location information received from a base station.

4. The method of claim 1, further comprising:
receiving, from a base station, a first message based on a first request for a reactivation of a PDU session from the UE; and
transmitting, to the base station, a second message for accepting the first request, the second message including a result of the reactivation of the PDU session,
wherein, in case that the result of the reactivation of the PDU session is failure, the second message further includes an error cause of the failure and
wherein the error cause indicates that user plane resources for the PDU session cannot be established because the UE is not present in the first area.

5. The method of claim 4, wherein, based on the error cause, a second request for the reactivation of the PDU session from the UE is not received for a certain duration of time.

6-12. (canceled)

13. A method performed by a session management function (SMF) entity in a wireless communication system, the method comprising:
transmitting, to an access management function (AMF) entity, single network slice selection assistance information (S-NSSAI) for requesting the AMF entity to report whether a user equipment (UE) is present in a first area; and
receiving, from the AMF entity, a notification of whether the UE is present in the first area, based on the S-NSSAI,
wherein, in case that the UE is not present in the first area, downlink user data is not transmitted.

14. The method of claim 13, wherein, in case that the UE is not present in the first area:
a protocol data unit (PDU) session is deactivated, and
user plane resources associated the PDU session is released.

15. The method of claim 13, wherein the notification of whether the UE is present in the first area is received based on UE location information received from a base station.

16. An access management function (AMF) entity in a wireless communication system, the AMF entity comprising:
a transceiver; and
a controller coupled with the transceiver and configured to:
receive, from a session management function (SMF) entity, single network slice selection assistance information (S-NSSAI) for requesting the AMF entity to report whether a user equipment (UE) is present in a first area,
determine whether the UE is present in the first area, and
transmit, to the SMF, a notification of whether the UE is present in the first area, based on the S-NSSAI,
wherein, in case that the UE is not present in the first area, downlink user data is not transmitted.

17. The AMF of claim 16, wherein, in case that the UE is not present in the first area:
a protocol data unit (PDU) session is deactivated, and
user plane resources associated the PDU session is released.

18. The AMF of claim 16, wherein the determining whether the UE is present in the first area is based on UE location information received from a base station.

19. The AMF of claim 16, wherein the controller is further configured to:
receive, from a base station, a first message based on a first request for a reactivation of a PDU session from the UE, and
transmit, to the base station, a second message for accepting the first request, the second message including a result of the reactivation of the PDU session, and
wherein, in case that the result of the reactivation of the PDU session is failure, the second message further includes an error cause of the failure and the cause indicates that that the UE is not in a second area of a network slice of the PDU Session, and
wherein the error cause indicates that user plane resources for the PDU session cannot be established because the UE is not present in the first area.

20. The AMF of claim 19, wherein, based on the error cause, a second request for the reactivation of the PDU session from the UE is not received for a certain duration of time.

21. A session management function (SMF) entity in a wireless communication system, the SMF comprising:
a transceiver; and
a controller coupled with the transceiver and configured to:
transmit, to an access management function (AMF) entity, single network slice selection assistance information (S-NSSAI) for requesting the AMF entity to report whether a user equipment (UE) is present in a first area, and
receive, from the AMF entity, a notification of whether the UE is present in the first area, based on the S-NSSAI,
wherein, in case that the UE is not present in the first area, downlink user data is not transmitted.
